(19) United States
(12) Patent Application Publication
(10) Pub. No.: US 2024/0323894 A1
(43) Pub. Date: Sep. 26, 2024

(54) POSITIONING MEASUREMENT RESULT SENDING METHOD AND APPARATUS, POSITIONING MEASUREMENT RESULT RECEIVING METHOD AND APPARATUS, AND COMMUNICATION DEVICE

(71) Applicant: BEIJING XIAOMI MOBILE SOFTWARE CO., LTD., Beijing (CN)

(72) Inventor: Mingju LI, Beijing (CN)

(73) Assignee: BEIJING XIAOMI MOBILE SOFTWARE CO., LTD., Beijing (CN)

(21) Appl. No.: 18/290,012

(22) PCT Filed: May 10, 2021
(86) PCT No.: PCT/CN2021/092689

§ 371 Date: Nov. 8, 2023

(51) Int. Cl. H04W 64/00; H04L 5/00; H04W 72/1268; H04W 72/231; H04W 76/20

(52) U.S. Cl. CPC H04W 64/00; H04L 5/0051; H04W 72/1268; H04W 72/231; H04W 76/20

(57) ABSTRACT

A positioning measurement result sending method includes: a user equipment (UE) obtaining a positioning measurement result, and sending the positioning measurement result by means of a PUSCH resource.

### CROSS REFERENCE TO RELATED APPLICATION

This application is a national phase application of International Application No. PCT/CN2021/092689, filed on May 10, 2021, which is incorporated by reference herein in its entireties for all purposes.

### BACKGROUND

The downlink PRS (Positioning Reference Signal) is newly defined in the NR (New Radio) Rel-16 system, in which, as far as PRS is concerned, periodically transmitted PRS is generally supported, and repeated transmission of PRS resources within a period is supported. Herein, regarding the repeated transmission, the number of repeated transmission(s) in the period and the time interval between every two transmissions are further configured, where the time interval is N slots, and N is a natural number. Therefore, at present, PRS can only be sent once in a slot, the number of symbols occupied by PRS can be 2, 4, 6, and 12 consecutive symbols in the slot, and the starting symbol position can be any symbol of the 1st to 13th symbols in the slot.

In related art, UE (User Equipment) can measure the PRS, obtain a positioning measurement result, and directly send the positioning measurement result to a base station; then the base station transparently transmits the positioning measurement result to the LMF (Location Management Function).

### SUMMARY

This disclosure relates to the technical field of wireless communication, and in particular, to methods for sending and receiving a positioning measurement result, apparatuses thereof, and a communication device.

According to a first aspect of embodiments of this disclosure, a positioning measurement result sending method is provided, which is applied to a UE and includes: acquiring a positioning measurement result; and sending the positioning measurement result through a physical uplink shared channel (PUSCH) resource.

According to a second aspect of embodiments of this disclosure, a positioning measurement result receiving method is provided, which is applied to a network device and includes: receiving a positioning measurement result through a PUSCH resource.

According to a third aspect of embodiments of this disclosure, a communication device is provided and includes: a transceiver; a memory; and a processor, connected to the transceiver and the memory respectively, and configured to, through executing computer-executable instructions on the memory, control wireless signal transmission and reception of the transceiver, and implement the positioning measurement result sending method according to the first aspect of embodiments of this disclosure, or the positioning measurement result receiving method according to the second aspect of embodiments of this disclosure.

Additional aspects and advantages of the disclosure will be set forth in part in the description which follows, and in part will be obvious from the description, or may be learned by practice of the disclosure.

### BRIEF DESCRIPTION OF THE DRAWINGS

The above and/or additional aspects and advantages of this disclosure will become apparent and understandable from the following description of the embodiments in conjunction with the accompanying drawings. In the drawings:

FIG. 1 is a schematic flowchart of a positioning measurement result sending method according to some embodiments of this disclosure;

FIG. 2 is a schematic flowchart of another positioning measurement result sending method according to some embodiments of this disclosure;

FIG. 3 is a schematic flowchart of another positioning measurement result sending method according to some embodiments of this disclosure;

FIG. 4 is a schematic flowchart of another positioning measurement result sending method according to some embodiments of this disclosure;

FIG. 5 is a schematic flowchart of another positioning measurement result sending method according to some embodiments of this disclosure;

FIG. 6 is a schematic flowchart of another positioning measurement result sending method according to some embodiments of this disclosure;

FIG. 7 is a schematic flowchart of another positioning measurement result sending method according to some embodiments of this disclosure;

FIG. 8 is a schematic flowchart of another positioning measurement result sending method according to some embodiments of this disclosure;

FIG. 9 is a schematic flowchart of a positioning measurement result receiving method according to some embodiments of this disclosure;

FIG. 10 is a schematic block diagram of a positioning measurement result sending apparatus according to some embodiments of this disclosure;

FIG. 11 is a schematic block diagram of a positioning measurement result receiving apparatus according to some embodiments of this disclosure;

FIG. 12 is a block diagram of a UE according to some embodiments of this disclosure;

FIG. 13 is a schematic structural diagram of a network device according to some embodiments of this disclosure.

### DETAILED DESCRIPTION

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the embodiments of this disclosure. Rather, they are merely examples of apparatuses and methods consistent with aspects of the disclosed embodiments as recited in the appended claims.

Terms used in the embodiments of this disclosure are for the purpose of describing specific embodiments only, and are not intended to limit the embodiments of this disclosure. As used in the examples of this disclosure and the appended claims, the singular forms “a” and “the” are also intended to include the plural unless the context clearly dictates otherwise. It should also be understood that the term “and/or” as used herein refers to and includes any and all possible combinations of one or more of the associated listed items.

It should be understood that although the embodiments of this disclosure may use the terms “first”, “second”, “third”, and the like to describe various information, the information should not be limited to these terms. These terms are only used to distinguish information of the same type from one another. For example, without departing from the scope of the embodiments of this disclosure, first information may also be called second information, and similarly, second information may also be called first information. Depending on the context, the words “if . . . ” and “in case . . . ” as used herein may be interpreted as “upon . . . ” or “when . . . ” or “in response to determining that . . . .”

Embodiments of this disclosure are described in detail below, examples of which are illustrated in the accompanying drawings, where the same or similar reference numerals designate the same or similar elements throughout the disclosure. The embodiments described below by referring to the drawings are exemplary and are intended to explain this disclosure, but should not be construed as limiting this disclosure.

In related art, the UE directly sends the positioning measurement result to the base station through a signal, and then the base station transparently transmits the positioning measurement result to the LMF, that is, uses the LMF to perform positioning position determination.

However, the above-mentioned reporting method of the positioning measurement result has a large reporting time delay.

In view of the above problems, this disclosure provides positioning measurement result sending and receiving methods, apparatuses thereof, and a communication device.

FIG. 1 is a schematic flowchart of a positioning measurement result sending method according to some embodiments of this disclosure. The positioning measurement result sending method can be applied to a UE.

In some embodiments, the UE may be a device that provides voice and/or data connectivity to a user, a handheld device with a wireless connection function, other processing devices connected to a wireless modem, and the like. In different systems, the name of the UE may be different. For example, a wireless UE may communicate with one or more CN (Core Network) via RAN (Radio Access Network), and the wireless UE may be a mobile terminal device, such as a mobile phone (or called “cellular” phone) and a computer with mobile terminal device, for example, pocket, hand-held, computer built-in or vehicle-mounted mobile devices, which exchange voice and/or data with the radio access network.

For example, the UE may be a PCS (Personal Communication Service) phone, a cordless phone, a SIP (Session Initiated Protocol) phone, a WLL (Wireless Local Loop) station, a PDA (Personal Digital Assistant) and other devices. The wireless UE may also be called a system, a subscriber unit, a subscriber station, a mobile station, a mobile site, a remote station, an access point, a remote terminal, an access terminal, a user terminal, a user agent, a user device, and the like, which are not limited in the embodiments of this disclosure.

As shown in FIG. 1, the positioning measurement result sending method may include the following steps.

In step 101, a positioning measurement result is acquired.

In some embodiments of this disclosure, the UE may acquire the positioning measurement result by measuring a PRS (Positioning Reference Signal).

In step 102, the positioning measurement result is sent through a PUSCH (Physical Uplink Shared Channel) resource(s).

In some embodiments of this disclosure, after acquiring the positioning measurement result, the UE may send the positioning measurement result to the network device through the PUSCH resource. Therefore, compared with the manner of sending the positioning measurement result to the core network device such as LMF, sending the positioning measurement result to the network device through the PUSCH resource can reduce the reporting delay of the positioning measurement result, thereby reducing the positioning delay and improving the positioning accuracy.

In some embodiments, a base station is taken as an example of the network device. The base station may include multiple cells that provide services for UEs. Depending on the specific application, each cell may contain multiple TRPs (Transmission Reception Points or Transmit Receive Points), each TRP may contain one or more antenna panels. Alternatively, the base station may be a device in the access network that communicates with wireless terminal devices through one or more sectors on the air interface, or may be referred to as other names. For example, the base station involved in some embodiments of this disclosure may be a BTS (Base Transceiver Station) in GSM (Global System for Mobile communications) or CDMA (Code Division Multiple Access), a NodeB in WCDMA (Wide-band Code Division Multiple Access), an evolutional Node B (referred to as eNB or e-NodeB) in LTE (long term evolution) system, or a 5G base station (referred to as gNB) in the 5G network architecture (next generation system); it may also be HeNB (Home evolved Node B), a relay node, a femto, a pico, and the like, which are not limited in the embodiments of this disclosure.

In the positioning measurement result sending method according to some embodiments of this disclosure, the UE acquires the positioning measurement result, and sends the positioning measurement result through the PUSCH resource. In this way, sending the positioning measurement result to the network device through the PUSCH resource can reduce the reporting time delay of the positioning measurement result, thereby reducing the positioning time delay and improving the positioning accuracy.

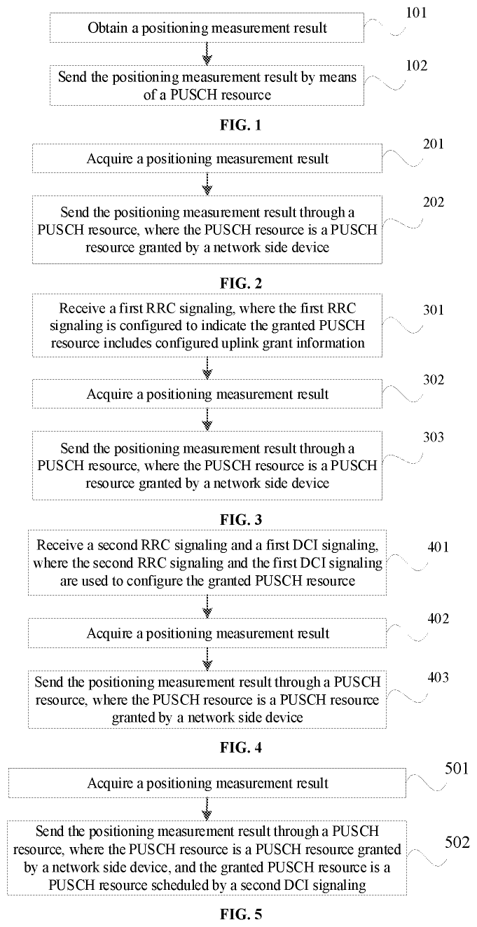

Some embodiments of this disclosure provide another positioning measurement result sending method, and FIG. 2 is a schematic flowchart of the another positioning measurement result sending method according to some embodiments of this disclosure. The positioning measurement result sending method can be applied to a UE. The positioning measurement result sending method may be implemented alone, or may be implemented in combination with any other embodiments in this disclosure or any possible implementation manner in some embodiments, or may be implemented in combination with any technical solution in related art.

As shown in FIG. 2, the positioning measurement result sending method may include the following steps.

In step 201, a positioning measurement result is acquired.

In some embodiments of this disclosure, step 201 may be implemented in any manner described in the embodiments of this disclosure, which is not limited in the embodiments of this disclosure and will not be repeated here.

In step 202, the positioning measurement result is sent through a PUSCH resource, where the PUSCH resource is a PUSCH resource granted by a network device.

In some embodiments of this disclosure, the network device may configure a granted PUSCH resource, and the UE may send the positioning measurement result by using the granted PUSCH resource configured by the network device.

In the positioning measurement result sending method according to some embodiments of this disclosure, the UE acquires the positioning measurement result, and sends the positioning measurement result through the PUSCH resource. In this way, sending the positioning measurement result to the network device through the PUSCH resource can reduce the reporting time delay of the positioning measurement result, thereby reducing the positioning time delay and improving the positioning accuracy.

It should be noted that the foregoing possible implementation manners may be implemented individually or in combination, which is not limited in the embodiments of this disclosure.

Some embodiments of this disclosure provide another positioning measurement result sending method, and FIG. 3 is a schematic flowchart of the another positioning measurement result sending method according to some embodiments of this disclosure. The positioning measurement result sending method can be applied to a UE. The positioning measurement result sending method may be implemented alone, or may be implemented in combination with any other embodiments in this disclosure or any possible implementation manner in some embodiments, or may be implemented in combination with any technical solution in related art.

As shown in FIG. 3, the positioning measurement result sending method may include the following steps.

In step 301, a first RRC (Radio Resource Control) signaling is received, where the first RRC signaling is used to indicate a granted PUSCH resource, and the first RRC signaling includes configured uplink grant information.

In some embodiments of this disclosure, the network device can configure UL (Uplink) grant information and the granted PUSCH resource, which is also called configured grant PUSCH transmission. For example, the network device may indicate, through the first RRC signaling, the configured uplink grant information and the granted PUSCH resource.

In some embodiments of this disclosure, the network device may send the first RRC signaling to the UE; and correspondingly, the UE may receive the first RRC signaling sent by the network device, and determine the granted PUSCH resource according to the first RRC signaling.

In a possible implementation of some embodiments of this disclosure, the first RRC signaling may include rrc-ConfiguredUplinkGrant, and the UE may directly determine the uplink grant information according to the first RRC signaling without monitoring the uplink grant information (UL grant) in the DCI (Downlink Control Information). The PUSCH configured through the first RRC signaling is also called configured grant Type 1 PUSCH transmission.

Herein, rrc-ConfiguredUplinkGrant may include at least one of following: timeDomainOffset; timeDomainAllocation; frequencyDomainAllocation; antennaPort; dmrs-SeqInitialization; precodingAndNumberOfLayers; srs-ResourceIndicator; mcsAndTBS; frequencyHoppingOffset; pathlossReferenceIndex; pusch-RepTypeIndicator-r16; frequency HoppingPUSCH-RepTypeB-r16; timeReferenceSFN-r16.

As an example, rrc-ConfiguredUplinkGrant may be, for example:
rrc-ConfiguredUplinkGrant SEQUENCE{
   timeDomainOffset
   timeDomainAllocation
   frequency DomainAllocation
   antennaPort
   dmrs-SeqInitialization
   precodingAndNumberOfLayers
   srs-ResourceIndicator
   mcsAndTBS
   frequency HoppingOffset
   pathlossReferenceIndex
   pusch-RepTypeIndicator-r16
   frequency HoppingPUSCH-RepTypeB-r16
   timeReferenceSFN-r16
}

Herein, SEQUENCE refers to appearing in sequence.

The first RRC signaling further includes at least one of the following: PUSCH period, modulation and coding scheme, and the like. Since the PUSCH resource configured by the first RRC signaling can be obtained periodically, the time for requesting the PUSCH resource can be saved at the UE, thereby reducing the time delay.

In step 302, a positioning measurement result is acquired.

In some embodiments of this disclosure, step 302 may be implemented in any manner described in the embodiments of this disclosure, which is not limited in some embodiments of this disclosure and will not be repeated here.

In step 303, the positioning measurement result is sent through a PUSCH resource, where the PUSCH resource is the granted PUSCH resource.

In some embodiments of this disclosure, the UE may send the positioning measurement result by using the granted PUSCH resource configured by the network device.

In a possible implementation of some embodiments of this disclosure, the number of granted PUSCH resource configured by the network device may be at least one in one period/cycle. When the number of granted PUSCH resource indicated in the first RRC signaling is one, the UE may send the positioning measurement result by using the granted PUSCH resource. When the number of granted PUSCH resources indicated in the first RRC signaling is multiple, the UE may send the positioning measurement result by using one of the multiple granted PUSCH resources.

As a possible implementation manner, the first RRC signaling may further include an indicator, where the indicator is used to indicate the granted PUSCH resource for sending the positioning measurement result.

For example, when the first RRC signaling indicates two granted PUSCH resources, an indicator may be used to indicate one of the two granted PUSCH resources as the granted PUSCH resource used for sending the positioning measurement result.

It should be noted that the above is only an example in which step 301 is implemented before step 302, but this disclosure is not limited thereto. In practical applications, step 301 may also be implemented in parallel with step 302, or step 301 may also be implemented after step 302 and before step 303, which is not limited.

In the positioning measurement result sending method according to some embodiments of this disclosure, the UE acquires the positioning measurement result, and sends the positioning measurement result through the PUSCH resource. In this way, sending the positioning measurement result to the network device through the PUSCH resource can reduce the reporting time delay of the positioning measurement result, thereby reducing the positioning time delay and improving the positioning accuracy.

It should be noted that the foregoing possible implementation manners may be implemented individually or in combination, which is not limited in some embodiments of this disclosure.

Some embodiments of this disclosure provide another positioning measurement result sending method, and FIG. 4 is a schematic flowchart of the another positioning measurement result sending method according to some embodiments of this disclosure. The positioning measurement result sending method can be applied to a UE. The positioning measurement result sending method may be implemented alone, or may be implemented in combination with any other embodiments in this disclosure or any possible implementation manner in some embodiments, or may be implemented in combination with any technical solution in related art.

As shown in FIG. 4, the positioning measurement result sending method may include the following steps.

In step 401, a second RRC signaling and a first DCI signaling are received, where the second RRC signaling and first DCI signaling are used to configure a granted PUSCH resource.

In some embodiments of this disclosure, the network device may configure the granted PUSCH resource. For example, the network device may configure the granted PUSCH resource through the second RRC signaling and the first DCI signaling.

It should be noted that this application does not limit the timing of sending the second RRC signaling and the first DCI signaling by the network device. For example, the second RRC signaling and the first DCI signaling may be sent successively, or may also be sent at the same time.

As an example, rrc-ConfiguredUplinkGrant may not be included in the second RRC signaling, and the parameter(s) in rrc-ConfiguredUplinkGrant may be indicated through the first DCI signaling. The PUSCH configured through the second RRC signaling and the first DCI signaling is also called configured grant Type 2 PUSCH transmission.

As an example, the second RRC signaling further includes at least one of the following: a PUSCH period, a modulation and coding scheme, and the like.

In some embodiments of this disclosure, the UE may receive the second RRC signaling and the first DCI signaling sent by the network device, and determine the PUSCH resource granted by the network device according to the second RRC signaling and the first DCI signaling.

In a possible implementation of the embodiments of this disclosure, the UE may determine, according to the first DCI signaling, at least one of the following aspects of information.

In a first aspect, it is determined whether to trigger reporting of the positioning measurement result according to the first DCI signaling. If it is determined to trigger the reporting of the positioning measurement result according to the first DCI signaling, the execution of subsequent steps 402 to 403 may be triggered; if it is determined not to trigger the reporting of the positioning measurement result according to the first DCI signaling, then the subsequent steps 402 to 403 may not be performed.

In a second aspect, it is determined whether to transmit the positioning measurement result on the granted PUSCH resource according to the first DCI signaling. If it is determined to transmit the positioning measurement result on the granted PUSCH resource according to the first DCI signaling, after acquiring the positioning measurement result, the positioning measurement result may be transmitted on the granted PUSCH resource. If it is determined, according to the first DCI signaling, that the positioning measurement result is not transmitted on the granted PUSCH resource, it is unnecessary to send the positioning measurement result to the network device until the network device configures the granted PUSCH resource for transmitting the positioning measurement result.

In a third aspect, an identifier of the granted PUSCH resource for sending the positioning measurement result is determined according to the first DCI signaling. For example, when the second RRC signaling and the first DCI signaling configure at least two PUSCH resources in one cycle, the identifier of the granted PUSCH resource for sending the positioning measurement result may be indicated through the first DCI signaling. In this way, the UE can determine the granted PUSCH resource for sending the positioning measurement result according to the above identifier, and send the positioning measurement result according to the granted PUSCH resource.

In a fourth aspect, information on measurement gap for measuring the PRS is determined according to the first DCI signaling.

The information on measurement gap for measuring the PRS includes at least one of the following: whether to trigger the measurement gap, the period and time offset of the measurement gap, and the length of time occupied by the measurement gap in each period.

In a fifth aspect, information on BWP (Bandwidth Part) ID for measuring the PRS is determined according to the first DCI signaling.

In a sixth aspect, information on panel for measuring the PRS is determined according to the first DCI signaling.

In step 402, a positioning measurement result is acquired.

In step 403, the positioning measurement result is sent through a PUSCH resource, where the PUSCH resource is the granted PUSCH resource.

In some embodiments of this disclosure, steps 402 to 403 may be implemented in any one of the embodiments of this disclosure, which is not limited in some embodiments of this disclosure and will not be repeated here.

It should be noted that the above is only an example in which step 401 is implemented before step 402, but this disclosure is not limited thereto. In practical applications, step 401 may also be implemented in parallel with step 402, or step 401 may also be implemented after step 402 and before step 403, which is not limited herein.

In the positioning measurement result sending method according to some embodiments of this disclosure, the UE acquires the positioning measurement result, and sends the positioning measurement result through the PUSCH resource. In this way, sending the positioning measurement result to the network device through the PUSCH resource can reduce the reporting time delay of the positioning measurement result, thereby reducing the positioning time delay and improving the positioning accuracy.

It should be noted that the foregoing possible implementation manners may be implemented individually or in combination, which is not limited in some embodiments of this disclosure.

Some embodiments of this disclosure provide another positioning measurement result sending method, and FIG. 5 is a schematic flowchart of the another positioning measurement result sending method according to some embodiments of this disclosure. The positioning measurement result sending method can be applied to a UE. The positioning measurement result sending method may be implemented alone, or may be implemented in combination with any other embodiments in this disclosure or any possible implementation manner in some embodiments, or may be implemented in combination with any technical solution in related art.

As shown in FIG. 5, the positioning measurement result sending method may include the following steps.

In step 501, a positioning measurement result is acquired.

In some embodiments of this disclosure, step 501 may be implemented in any manner in some embodiments of this disclosure, which is not limited in some embodiments of this disclosure and will not be repeated here.

In step 502, the positioning measurement result is sent through a PUSCH resource, where the PUSCH resource is a PUSCH resource granted by a network device, and the granted PUSCH resource is a PUSCH resource scheduled by a second DCI signaling.

In some embodiments of this disclosure, the network device can configure the granted PUSCH resource. For example, the network device may dynamically schedule the granted PUSCH resource through the second DCI signaling, so that the UE can receive the second DCI signaling sent by the network device, and using the PUSCH resource dynamically scheduled by the second DCI signaling as the PUSCH resource granted by the network device.

In some embodiments of this disclosure, after acquiring the positioning measurement result, the UE may send the positioning measurement result through the PUSCH resource granted by the network device.

In a possible implementation of the embodiments of this disclosure, the number of PUSCH resource scheduled by the second DCI signaling may be at least one. When the number of PUSCH resource scheduled by the second DCI signaling is one, the UE may use the uniquely scheduled PUSCH resource as the granted PUSCH resource, so that the positioning measurement result can be sent through the granted PUSCH resource. When the number of PUSCH resources scheduled by the second DCI signaling is multiple, the UE may use one of the multiple PUSCH resources scheduled by the second DCI signaling as the granted PUSCH resource for sending the positioning measurement result, so that the UE can send the positioning measurement result through the granted PUSCH resource.

As a possible implementation manner, when the second DCI signaling schedules multiple PUSCH resources, a PUSCH resource at a specified position among the multiple PUSCH resources carries the positioning measurement result. In other words, the PUSCH resource at the specified position among multiple PUSCH resources scheduled by the second DCI signaling may be used as the granted PUSCH resource for sending the positioning measurement result, so that the UE may send the positioning measurement result through the granted PUSCH resource.

For example, when the second DCI signaling schedules two PUSCH resources, the PUSCH resource at the specified position may be a PUSCH resource at the second position. When the second DCI signaling schedules more than two PUSCH resources, the PUSCH resource at the specified position may be a PUSCH resource at the penultimate position. It should be understood that the above examples are only illustrative, and this disclosure is not limited thereto, and the specified position may also be other positions.

In some embodiments, the PUSCH resources at different positions scheduled by the second DCI signaling may be different from at least one of the following: time domain resources; frequency domain resources; air domain resources (antenna port); beam (TCI (Transmission Configuration Indication) status or spatial setting).

In a possible implementation of some embodiments of this disclosure, the second DCI signaling may further include a reporting type of the positioning measurement result, where the reporting type may include periodic reporting, aperiodic reporting, or semi-persistent report.

In a possible implementation manner of some embodiments of this disclosure, the second DCI signaling may further include at least one of the following types of information.

The first type is whether to transmit the positioning measurement result on the granted PUSCH resource. If the second DCI signaling indicates to transmit the positioning measurement result on the granted PUSCH resource, the UE acquires the positioning measurement result after receiving the second DCI signaling, and transmits the positioning measurement result on the granted PUSCH resource.

The second type is the identifier of the granted PUSCH resource used for sending the positioning measurement result. For example, when at least two PUSCH resources are scheduled by the second DCI signaling, the identifier of the granted PUSCH resource for sending the positioning measurement result may be indicated through the second DCI signaling. In this way, the UE can determine the granted PUSCH resource for sending the positioning measurement result according to the above identifier, and send the positioning measurement result according to the granted PUSCH resource.

The third type is the time domain position of the PUSCH resource.

The fourth type is information on the measurement gap for measuring the PRS.

The fifth type is information on the BWP ID for measuring the PRS.

The sixth type is information on the panel for measuring the PRS.

The information on the measurement gap for measuring the PRS includes at least one of the following: whether to trigger the measurement gap, the period and time offset of the measurement gap, and the length of time occupied by the measurement gap in each period.

In the positioning measurement result sending method according to some embodiments of this disclosure, the UE acquires the positioning measurement result, and sends the positioning measurement result through the PUSCH resource. In this way, sending the positioning measurement result to the network device through the PUSCH resource can reduce the reporting time delay of the positioning measurement result, thereby reducing the positioning time delay and improving the positioning accuracy.

It should be noted that the foregoing possible implementation manners may be implemented individually or in combination, which is not limited in some embodiments of this disclosure.

Some embodiments of this disclosure provide another positioning measurement result sending method, and FIG. 6 is a schematic flowchart of the another positioning measurement result sending method according to some embodiments of this disclosure. The positioning measurement result sending method can be applied to a UE. The positioning measurement result sending method may be implemented alone, or may be implemented in combination with any other embodiments in this disclosure or any possible implementation manner in some embodiments, or may be implemented in combination with any technical solution in related art.

As shown in FIG. 6, the positioning measurement result sending method may include the following steps.

In step 601, a positioning measurement result is acquired.

In step 602, the positioning measurement result is sent through a PUSCH resource, where the PUSCH resource is a PUSCH resource granted by the network device, and the granted PUSCH resource carries only the positioning measurement result.

In some embodiments of this disclosure, step 601 and value 602 may be implemented in any one of the embodiments of this disclosure, which is not limited in some embodiments of this disclosure and will not be repeated here.

In some embodiments of this disclosure, the PUSCH resource granted by the network device may only carry the positioning measurement result.

In some embodiments, the above granted PUSCH resource may be configured grant, that is, it may be a granted PUSCH resource (type 1) indicated through the first RRC signaling, or may be a granted PUSCH resource (type 2) indicated through the second RRC signaling and the first DCI signaling. Alternatively, the above-mentioned granted PUSCH resource may also be dynamically scheduled through the second DCI signaling.

Optionally, when the granted PUSCH resource only carries the positioning measurement result, for the configured grant, only one PUSCH resource may be indicated by type 2, that is, through the second RRC signaling and the first DCI signaling, thereby serving as the granted PUSCH resource for sending the positioning measurement result. The network device may also dynamically schedule or configured grant a PUSCH resource through the second DCI signaling, which serves as the granted PUSCH resource for sending the positioning measurement result.

Optionally, for type1, on the basis of the first RRC signaling, a MAC CE (Medium Access Control-Control Element) signaling may be added to activate the granted PUSCH resource for sending the positioning measurement result.

Optionally, when the above-mentioned granted PUSCH resource is scheduled through the second DCI signaling, the second DCI signaling may further include report trigger information, where the report trigger information is used to trigger the UE to report the positioning measurement result.

In the positioning measurement result sending method according to some embodiments of this disclosure, the UE acquires the positioning measurement result, and sends the positioning measurement result through the PUSCH resource. In this way, sending the positioning measurement result to the network device through the PUSCH resource can reduce the reporting time delay of the positioning measurement result, thereby reducing the positioning time delay and improving the positioning accuracy.

It should be noted that the foregoing possible implementation manners may be implemented individually or in combination, which is not limited in some embodiments of this disclosure.

Some embodiments of this disclosure provide another positioning measurement result sending method, and FIG. 7 is a schematic flowchart of the another positioning measurement result sending method according to some embodiments of this disclosure. The positioning measurement result sending method can be applied to a UE. The positioning measurement result sending method may be implemented alone, or may be implemented in combination with any other embodiments in this disclosure or a possible implementation manner in some embodiments, or may be implemented in combination with any technical solution in related art.

As shown in FIG. 7, the positioning measurement result sending method may include the following steps.

In step 701, a positioning measurement result is acquired.

In some embodiments of this disclosure, step 701 may be implemented in any one of the embodiments of this disclosure, which is not limited in some embodiments of this disclosure and will not be repeated here.

In step 702, a reporting type of the positioning measurement result is determined.

It should be noted that, for any embodiment of this disclosure, the positioning measurement result may be reported periodically, or aperiodically, or semi-persistently.

In other words, in some embodiments of this disclosure, the reporting types of the positioning measurement result may include periodic reporting, aperiodic reporting, and semi-persistent reporting.

In some embodiments of this disclosure, the UE may determine the reporting type of the positioning measurement result.

As an example, the second DCI signaling may include the reporting type of the positioning measurement result, so that the UE may determine the reporting type of the positioning measurement result according to the second DCI signaling.

In step 703, the positioning measurement result is sent through the PUSCH resource according to the report type.

It should be noted that the explanation of the PUSCH resource in any of the foregoing embodiments is also applicable to other embodiments, and details are not repeated here.

In some embodiments of this disclosure, after determining the reporting type of the positioning measurement result, the UE may send the positioning measurement result through the PUSCH resource according to the reporting type. For example, when the reporting type is periodic reporting, the UE may periodically send the positioning measurement result through the periodically occurring PUSCH resource.

In the positioning measurement result sending method according to some embodiments of this disclosure, the UE acquires the positioning measurement result, and sends the positioning measurement result through the PUSCH resource. In this way, sending the positioning measurement result to the network device through the PUSCH resource can reduce the reporting time delay of the positioning measurement result, thereby reducing the positioning time delay and improving the positioning accuracy.

It should be noted that the foregoing possible implementation manners may be implemented individually or in combination, which is not limited in some embodiments of this disclosure.

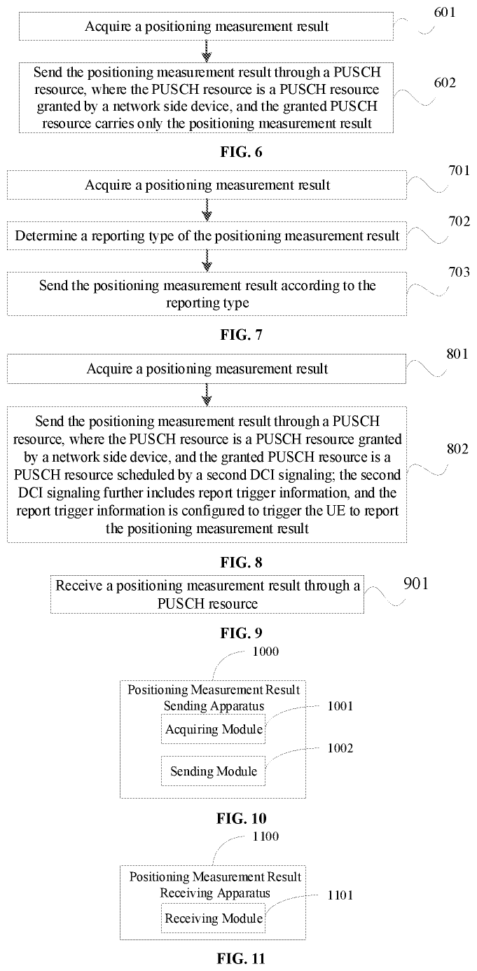

Some embodiments of this disclosure provide another positioning measurement result sending method, and FIG. 8 is a schematic flowchart of the another positioning measurement result sending method according to some embodiments of this disclosure. The positioning measurement result sending method can be applied to a UE. The positioning measurement result sending method may be implemented alone, or may be implemented in combination with any other embodiments in this disclosure or any possible implementation manner in some embodiments, or may be implemented in combination with any technical solution in related art.

As shown in FIG. 8, the positioning measurement result sending method may include the following steps.

In step 801, a positioning measurement result is acquired.

In step 802, the positioning measurement result is sent through a PUSCH resource, where the PUSCH resource is a PUSCH resource granted by a network device, the granted PUSCH resource is a PUSCH resource scheduled by a second DCI signaling, the second DCI signaling further includes report trigger information, and the report trigger information is used to trigger the UE to report the positioning measurement result.

In some embodiments of this disclosure, steps 801 to 802 may be implemented in any one of the embodiments of this disclosure, which is not limited in some embodiments of this disclosure and will not be repeated here.

In some embodiments of this disclosure, the second DCI signaling may further include the report trigger information, where the report trigger information is used to trigger the UE to report the positioning measurement result. After receiving the second DCI signaling sent by the network device, the UE may determine whether to trigger the reporting of the positioning measurement result according to the report trigger information in the second DCI signaling. When the UE determines to trigger the reporting of the positioning measurement result according to the report trigger information, the UE may send the positioning measurement result through the PUSCH resource; and when the UE determines that there is no need to trigger the reporting of the positioning measurement result according to the report trigger information, it does not need to send the positioning measurement result to the network device.

In a possible implementation manner of the embodiments of this disclosure, the second DCI signaling may further include at least one PRS resource set ID and/or at least one PRS resource ID to be measured.

Optionally, the TRP IDs and/or cell IDs corresponding to reference signal resources included in the same PRS resource set are the same.

Optionally, the TRP IDs and/or cell IDs corresponding to the reference signal resources included in the same PRS resource set are different.

In a possible implementation of the embodiments of this disclosure, the second DCI signaling may further include a time domain offset between the scheduled PUSCH resource and the second DCI signaling. For example, it may include a time domain offset between the PUSCH resource used for sending the positioning measurement result and the second DCI signaling.

In a possible implementation manner of the embodiments of this disclosure, a CSI (Channel State Information) request indicator field may be reused as an indicator field corresponding to the report trigger information.

In other words, the indicator field (or indicator bit) that triggers the reporting of the positioning measurement result may be the same as the indicator field used by the CSI request, while the difference lies in that the reference signal resource corresponding to the report trigger information is PRS, that is, the reference signal for acquiring the positioning measurement result is different from the reference signal resource used to obtain the CSI measurement result.

It should be noted that, in any embodiment of this disclosure, the positioning reference signal may be sent periodically, or may also be sent aperiodically, or may also be sent semi-persistently. The PRS may be an on-demand PRS requested by the UE, or the PRS may be an on-demand PRS requested by the network device (e.g., the PRS requested by a base station or LMF). This disclosure is not limited thereto.

In the positioning measurement result sending method according to some embodiments of this disclosure, the UE acquires the positioning measurement result, and sends the positioning measurement result through the PUSCH resource. In this way, sending the positioning measurement result to the network device through the PUSCH resource can reduce the reporting time delay of the positioning measurement result, thereby reducing the positioning time delay and improving the positioning accuracy.

It should be noted that the foregoing possible implementation manners may be implemented individually or in combination, which is not limited in some embodiments of this disclosure.

Some embodiments of this disclosure provide a positioning measurement result receiving method, and FIG. 9 is a schematic flowchart of the positioning measurement result receiving method according to some embodiments of this disclosure. The positioning measurement result receiving method can be applied to a network device. The positioning measurement result receiving method may be implemented alone, or may be implemented in combination with any other embodiments in this disclosure or any possible implementation manner in some embodiments, or may be implemented in combination with any technical solution in related art.

As shown in FIG. 9, the positioning measurement result receiving method may include the following steps.

In step 901, a positioning measurement result is received through a PUSCH resource.

In a possible implementation manner of some embodiments of this disclosure, the PUSCH resource is a PUSCH resource granted by the network device.

In a possible implementation manner of some embodiments of this disclosure, the network device may further send a first RRC signaling, where the first RRC signaling is configured to indicate the granted PUSCH resource, and the first RRC signaling includes configured uplink grant information.

In a possible implementation manner of some embodiments of this disclosure, the first RRC signaling further includes an indicator configured to indicate the granted PUSCH resource used for sending the positioning measurement result.

In a possible implementation manner of some embodiments of this disclosure, the network device may further send a second RRC signaling; and send a first DCI signaling, where the second RRC signaling and the first DCI signaling are used to configure the granted PUSCH resource.

In a possible implementation manner of some embodiments of this disclosure, the network device may further send a second DCI signaling, where the second DCI signaling is configured to schedule a PUSCH resource, and the granted PUSCH resource is the PUSCH resource scheduled by the second DCI signaling.

In a possible implementation manner of some embodiments of this disclosure, when the second DCI signaling schedules multiple PUSCH resources, a PUSCH resource at a specified position among the multiple PUSCH resources carries the positioning measurement result.

In a possible implementation manner of some embodiments of this disclosure, the second DCI signaling further includes a report type of the positioning measurement result.

In a possible implementation manner of some embodiments of this disclosure, the granted PUSCH resource carries only the positioning measurement result.

In a possible implementation manner of some embodiments of this disclosure, the second DCI signaling further includes report trigger information, and the report trigger information is configured to trigger a UE to report the positioning measurement result.

In a possible implementation manner of some embodiments of this disclosure, the second DCI signaling further includes at least one PRS resource set ID and/or at least one PRS resource ID to be measured.

In a possible implementation manner of some embodiments of this disclosure, the second DCI signaling further includes at least one of following: whether to transmit the positioning measurement result on the granted PUSCH resource; an identifier of the granted PUSCH resource used for sending the positioning measurement result; a time domain position of the PUSCH resource; information on a measurement gap for measuring a PRS; information on a BWP ID for measuring the PRS; information on a panel for measuring the PRS.

In a possible implementation manner of some embodiments of this disclosure, a CSI request indicator field is reused as an indicator field corresponding to the report trigger information.

It should be noted that the explanations of the method performed by the UE in any of the above-mentioned embodiments in FIG. 1 to FIG. 8 are also applicable to the method performed by the network device in some embodiments, and its implementation principles are similar, so details are not repeated here.

In the positioning measurement result receiving method according to some embodiments of this disclosure, the network device receives the positioning measurement result through the PUSCH resource. In this way, the UE sends the positioning measurement result to the network device through the PUSCH resource, which can reduce the reporting delay of the positioning measurement result, thereby reducing the positioning delay and improving the positioning accuracy.

It should be noted that the foregoing possible implementation manners may be implemented individually or in combination, which is not limited in some embodiments of this disclosure.

Corresponding to the positioning measurement result sending method provided in some embodiments of FIG. 1 to FIG. 8 as described above, this disclosure also provides a positioning measurement result sending apparatus. Since the positioning measurement result sending apparatus according to some embodiments of this disclosure corresponds to the positioning measurement result sending method according to some embodiments of FIG. 1 to FIG. 8 as described above, the implementation of the positioning measurement result sending method is also applicable to the positioning measurement result sending apparatus according to some embodiments of this disclosure, which will not be described in detail in the embodiments of this disclosure.

FIG. 10 is a schematic structural diagram of a positioning measurement result sending apparatus according to some embodiments of this disclosure. The apparatus can be applied in UE.

As shown in FIG. 10, the positioning measurement result sending apparatus 1000 may include an acquiring module 1001 and a sending module 1002.

The acquiring module 1001 is configured to acquire a positioning measurement result.

The sending module 1002 is configured to send the positioning measurement result through a PUSCH resource.

Optionally, the PUSCH resource is a PUSCH resource granted by the network device.

Optionally, the positioning measurement result sending apparatus 1000 may also include:
a first receiving module, configured to receive a first RRC signaling, where the first RRC signaling is used to indicate the granted PUSCH resource, and the first RRC signaling includes configured uplink grant information.

Optionally, the first RRC signaling further includes an indicator configured to indicate the granted PUSCH resource used for sending the positioning measurement result.

Optionally, the positioning measurement result sending apparatus 1000 may also include:
a second receiving module, configured to receive a second RRC signaling and a first DCI signaling, where the second RRC signaling and the first DCI signaling are used to configure the granted PUSCH resource.

Optionally, the positioning measurement result sending apparatus 1000 may also include:
a first determining module, configured to determine at least one of the following according to the first DCI signaling: whether to trigger reporting of the positioning measurement result; whether to transmit the positioning measurement result on the granted PUSCH resource; an identifier of the granted PUSCH resource used for sending the positioning measurement result; information on a measurement gap for measuring a PRS; information on a BWP ID for measuring the PRS; information on a panel for measuring the PRS.

Optionally, the granted PUSCH resource is a PUSCH resource scheduled by a second DCI signaling.

Optionally, when the second DCI signaling schedules multiple PUSCH resources, a PUSCH resource at a specified position among the multiple PUSCH resources carries the positioning measurement result.

Optionally, the second DCI signaling further includes a report type of the positioning measurement result.

Optionally, the granted PUSCH resource carries only the positioning measurement result.

Optionally, the positioning measurement result sending apparatus 1000 may also include:
a second determining module, configured to determine a reporting type of the positioning measurement result.

The sending module 1002 is further configured to send the positioning measurement result according to the reporting type.

Optionally, the second DCI signaling further includes report trigger information, and the report trigger information is configured to trigger the UE to report the positioning measurement result.

Optionally, the second DCI signaling further includes at least one PRS resource set ID and/or at least one PRS resource ID to be measured.

Optionally, the second DCI signaling further includes at least one of following: whether to transmit the positioning measurement result on the granted PUSCH resource; an identifier of the granted PUSCH resource used for sending the positioning measurement result; a time domain position of the PUSCH resource; information on a measurement gap for measuring a PRS; information on a BWP ID for measuring the PRS; information on a panel for measuring the PRS.

Optionally, a CSI request indicator field is reused as an indicator field corresponding to the report trigger information.

The positioning measurement result sending apparatus according to some embodiments of this disclosure acquires the positioning measurement result through UE, and sends the positioning measurement result through the PUSCH resource. In this way, sending the positioning measurement result to the network device through the PUSCH resource can reduce the reporting time delay of the positioning measurement result, thereby reducing the positioning time delay and improving the positioning accuracy.

Corresponding to the positioning measurement result receiving method provided in some embodiments of FIG. 9 as described above, this disclosure also provides a positioning measurement result receiving apparatus. Since the positioning measurement result receiving apparatus according to some embodiments of this disclosure corresponds to the positioning measurement result receiving method according to some embodiments of FIG. 9 as described above, the implementation of the positioning measurement result receiving method is also applicable to the positioning measurement result receiving apparatus according to some embodiments of this disclosure, which will not be described in detail in the embodiments of this disclosure.

FIG. 11 is a schematic structural diagram of the positioning measurement result receiving apparatus according to some embodiments of this disclosure. The apparatus can be applied to a network device.

As shown in FIG. 11, the positioning measurement result receiving apparatus 1100 may include a receiving module 1101.

The receiving module 1101 is configured to receive a positioning measurement result through a PUSCH resource.

Optionally, the PUSCH resource is a PUSCH resource granted by the network device.

Optionally, the positioning measurement result receiving apparatus 1100 may also include:
a first sending module, configured to send a first RRC signaling, where the first RRC signaling is used to indicate the granted PUSCH resource, and the first RRC signaling includes configured uplink grant information.

Optionally, the first RRC signaling further includes an indicator configured to indicate the granted PUSCH resource used for sending the positioning measurement result.

Optionally, the positioning measurement result receiving apparatus 1100 may also include:
a second sending module, configured to send a second RRC signaling; and send a first DCI signaling, where the second RRC signaling and the first DCI signaling are used to configure the granted PUSCH resource.

Optionally, the positioning measurement result receiving apparatus 1100 may also include:
a third sending module, configured to send a second DCI signaling, where the second DCI signaling is used to schedule a PUSCH resource, and the granted PUSCH resource is the PUSCH resource scheduled by the second DCI signaling.

Optionally, when the second DCI signaling schedules multiple PUSCH resources, a PUSCH resource at a specified position among the multiple PUSCH resources carries the positioning measurement result.

Optionally, the second DCI signaling further includes a report type of the positioning measurement result.

Optionally, the granted PUSCH resource carries only the positioning measurement result.

Optionally, the second DCI signaling further includes report trigger information, and the report trigger information is configured to trigger a UE to report the positioning measurement result.

Optionally, the second DCI signaling further includes at least one PRS resource set ID and/or at least one PRS resource ID to be measured.

Optionally, the second DCI signaling further includes at least one of following: whether to transmit the positioning measurement result on the granted PUSCH resource; an identifier of the granted PUSCH resource used for sending the positioning measurement result; a time domain position of the PUSCH resource; information on a measurement gap for measuring a PRS; information on a BWP ID for measuring the PRS; information on a panel for measuring the PRS.

Optionally, a CSI request indicator field is reused as an indicator field corresponding to the report trigger information.

The positioning measurement result receiving apparatus according to some embodiments of this disclosure receives the positioning measurement result at the network device through the PUSCH resource. In this way, the UE sends the positioning measurement result to the network device through the PUSCH resource, which can reduce the reporting delay of the positioning measurement result, thereby reducing the positioning delay and improving the positioning accuracy.

In order to implement the above embodiments, this disclosure also proposes a communication device.

The communication device according to some embodiments of this disclosure includes a processor, a transceiver, a memory, and an executable program stored on the memory and capable of being executed by the processor, where the foregoing method is implemented when the processor executes the executable program.

The communication device may be the aforementioned UE or network device.

In some embodiments, the memory may include various types of storage medium, which are non-transitory computer storage medium, and can continue to memorize and store information thereon after the communication device is powered off. Here, the communication device includes a UE or a network device.

The processor may be connected to the memory through a bus or the like, and is used to read the executable program stored in the memory and implemented as, for example, at least one of FIG. 1 to FIG. 9.

In order to realize the above-mentioned embodiments, this disclosure also proposes a computer storage medium.

The computer storage medium according to some embodiments of this disclosure stores an executable program. After the executable program is executed by a processor, the method according to any of the foregoing embodiments can be implemented as, for example, at least one of FIG. 1 to FIG. 9.

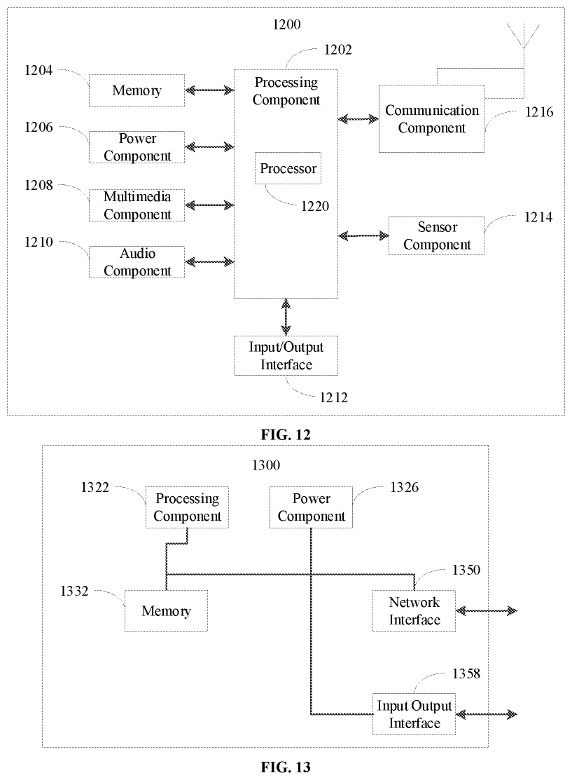

FIG. 12 is a block diagram of a UE 1200 according to some embodiments of this disclosure. For example, UE 1200 may be a mobile phone, computer, digital broadcast user equipment, messaging device, game console, tablet device, medical device, fitness device, personal digital assistant, or the like.

Referring to FIG. 12, UE 1200 may include at least one of the following components: a processing component 1202, a memory 1204, a power component 1206, a multimedia component 1208, an audio component 1210, an input/output (I/O) interface 1212, a sensor component 1214, and a communication component 1216.

The processing component 1202 generally controls the overall operations of the UE 1200, such as those associated with display, phone calls, data communications, camera operations, and recording operations. The processing component 1202 may include at least one processor 1220 to execute instructions to complete all or part of the steps of the above-mentioned method. Additionally, the processing component 1202 may include at least one module that facilitates interaction between the processing component 1202 and other components. For example, the processing component 1202 may include a multimedia module to facilitate interaction between the multimedia component 1208 and the processing component 1202.

The memory 1204 is configured to store various types of data to support operations at the UE 1200. Examples of such data include instructions for any application or method operating on UE 1200, contact data, phonebook data, messages, pictures, videos, and the like. The memory 1204 can be implemented by any type of volatile or non-volatile storage device or their combination, such as static random access memory (SRAM), electrically erasable programmable read-only memory (EEPROM), erasable programmable read only memory (EPROM), programmable read only memory (PROM), read only memory (ROM), magnetic memory, flash memory, magnetic or optical disk.

The power component 1206 provides power to various components of the UE 1200. Power component 1206 may include a power management system, at least one power supply, and other components associated with generating, managing, and distributing power for UE 1200.

The multimedia component 1208 includes a screen providing an output interface between the UE 1200 and the user. In some embodiments, the screen may include a liquid crystal display (LCD) and a touch panel (TP). If the screen includes a touch panel, the screen may be implemented as a touch screen to receive input signals from a user. The touch panel includes at least one touch sensor to sense touch, slide, and gestures on the touch panel. The touch sensor may not only sense a boundary of a touch or slide action, but also detect a wake-up time and pressure related to the touch or slide operation. In some embodiments, the multimedia component 1208 includes a front camera and/or a rear camera. When the UE 1200 is in an operation mode, such as a shooting mode or a video mode, the front camera and/or the rear camera can receive external multimedia data. Each of the front camera and the rear camera may be a fixed optical lens system or has focal length and optical zoom capability.

The audio component 1210 is configured to output and/or input audio signals. For example, the audio component 1210 includes a microphone (MIC), which is configured to receive an external audio signal when the UE 1200 is in an operation mode, such as a call mode, a recording mode, and a voice recognition mode. Received audio signals may be further stored in memory 1204 or sent via the communication component 1216. In some embodiments, the audio component 1210 also includes a speaker for outputting audio signals.

The I/O interface 1212 provides an interface between the processing component 1202 and a peripheral interface module, which may be a keyboard, a click wheel, a button, and the like. These buttons may include, but are not limited to: a home button, volume buttons, a start button, and a lock button.

The sensor component 1214 includes at least one sensor for providing various aspects of status assessment for the UE 1200. For example, the sensor component 1214 can detect the on/off state of the UE 1200, and the relative positioning of components, such as the display and the keypad of the UE 1200. The sensor component 1214 can also detect the position change of the UE 1200 or a component of the UE 1200, presence or absence of contact between the user and the UE 1200, orientation or acceleration/deceleration of the UE 1200 and temperature change of the UE 1200. The sensor assembly 1214 may include a proximity sensor configured to detect the presence of nearby objects in the absence of any physical contact. The sensor assembly 1214 may also include optical sensors, such as CMOS or CCD image sensors, for use in imaging applications. In some embodiments, the sensor component 1214 may also include an acceleration sensor, a gyroscope sensor, a magnetic sensor, a pressure sensor or a temperature sensor.

The communication component 1216 is configured to facilitate wired or wireless communications between UE 1200 and other devices. UE 1200 can access wireless networks based on communication standards, such as WiFi, 2G or 3G, or a combination thereof. In some exemplary embodiments, the communication component 1216 receives broadcast signals or broadcast related information from an external broadcast management system via a broadcast channel. In some exemplary embodiments, the communication component 1216 also includes a near field communication (NFC) module to facilitate short-range communication. For example, the NFC module may be implemented based on Radio Frequency Identification (RFID) technology, Infrared Data Association (IrDA) technology, Ultra Wide Band (UWB) technology, Bluetooth (BT) technology and other technologies.

In some exemplary embodiments, UE 1200 may be powered by at least one Application Specific Integrated Circuit (ASIC), Digital Signal Processor (DSP), Digital Signal Processing Device (DSPD), Programmable Logic Device (PLD), Field Programmable Gate Array (FPGA), a controller, a microcontroller, a microprocessor or other electronic components to implement the method shown in any one of the above-mentioned FIG. 1 to FIG. 8.

In some exemplary embodiments, there is also provided a non-transitory computer-readable storage medium including instructions, such as the memory 1204 including instructions, the instructions can be executed by the processor 1220 of the UE 1200 to implement the method described in any one of the above-mentioned FIG. 1 to FIG. 8. For example, the non-transitory computer readable storage medium may be ROM, random access memory (RAM), CD-ROM, magnetic tape, floppy disk, optical data storage device, and the like.

As shown in FIG. 13, it is a schematic structural diagram of a network device according to some embodiments of this disclosure. Referring to FIG. 13, the network device 1300 includes a processing component 1322, which further includes at least one processor, and a memory resource represented by a memory 1332 for storing instructions executable by the processing component 1322, such as an application program. The application program stored in memory 1332 may include one or more modules each corresponding to a set of instructions. In addition, the processing component 1322 is configured to execute instructions, so as to implement any of the aforementioned methods applied to the network device, for example, the method shown in FIG. 9.

The network device 1300 may also include a power component 1326 configured to perform power management of the network device 1300, a wired or wireless network interface 1350 configured to connect the network device 1300 to the network, and an input/output (I/O) interface 1358. The network device 1300 can operate based on the operating system stored in the memory 1332, such as Windows Server™, Mac OS X™, Unix™, Linux™, FreeBSD™ or similar.

Other embodiments of the disclosure will be readily apparent to those skilled in the art from consideration of the specification and practice of the invention disclosed herein. This disclosure is intended to cover any modification, use or adaptation of the present invention, these modifications, uses or adaptations follow the general principles of the present invention and include common knowledge or conventional technical means in the art not disclosed in this disclosure. The specification and examples are to be considered exemplary only, with a true scope and spirit of the disclosure being indicated by the following claims.

It should be understood that this disclosure is not limited to the precise constructions which have been described above and shown in the drawings, and various modifications and changes may be made without departing from the scope thereof. The scope of this disclosure is limited only by the appended claims.

1. A positioning measurement result sending method, comprising:
acquiring, by a user equipment (UE), a positioning measurement result; and
sending, by the UE, the positioning measurement result through a physical uplink shared channel (PUSCH) resource.

2. The method of claim 1, wherein the PUSCH resource is a PUSCH resource granted by a network device.

3. The method of claim 2, further comprising:
receiving, by the UE, a first radio resource control (RRC) signaling, wherein the first RRC signaling is configured to indicate the granted PUSCH resource, and the first RRC signaling comprises configured uplink grant information and an indicator,
wherein the indicator is configured to indicate the granted PUSCH resource configured for sending the positioning measurement result.

4. (canceled)

5. The method of claim 2, further comprising:
receiving, by the UE, a second RRC signaling and a first downlink control information (DCI) signaling, wherein the second RRC signaling and the first DCI signaling are configured for the granted PUSCH resource.

6. The method of claim 5, further comprising:
determining, by the UE according to the first DCI signaling, at least one of followings:
whether to trigger reporting of the positioning measurement result;
whether to transmit the positioning measurement result on the granted PUSCH resource;
an identifier of the granted PUSCH resource configured for sending the positioning measurement result;
information on a measurement gap for measuring a positioning reference signal (PRS);
information on a bandwidth part (BWP) ID for measuring the PRS; and
information on a panel for measuring the PRS.

7. The method of claim 2, wherein the granted PUSCH resource is a PUSCH resource scheduled by a second DCI signaling, and
wherein in response to the second DCI signaling scheduling multiple PUSCH resources, a PUSCH resource at a specified position among the multiple PUSCH resources carries the positioning measurement result; or the second DCI signaling further comprises a report type of the positioning measurement result.

8-9. (canceled)

10. The method of claim 2, wherein the granted PUSCH resource carries only the positioning measurement result.

11. The method of claim 1, further comprising:
determining, by the UE, a reporting type of the positioning measurement result; and
sending, by the UE, the positioning measurement result according to the reporting type.

12. The method of claim 7, wherein the second DCI signaling further comprises report trigger information, wherein the report trigger information is configured to trigger the UE to report the positioning measurement result, and
wherein the second DCI signaling further comprises at least one of at least one a PRS resource set and at least one a PRS resource ID to be measured; or a channel state information (CSI) request indicator filed is reused as an indicator field corresponding to the report trigger information.

13. (canceled)

14. The method of claim 7, wherein the second DCI signaling further comprises at least one of following:
whether to transmit the positioning measurement result on the granted PUSCH resource;
an identifier of the granted PUSCH resource used for sending the positioning measurement result;
a time domain position of the PUSCH resource;
information on a measurement gap for measuring a PRS;
information on a BWP ID for measuring the PRS; and
information on a panel for measuring the PRS.

15. (canceled)

16. A positioning measurement result receiving method, comprising:
receiving, by a network device, a positioning measurement result a physical uplink shared channel (PUSCH) resource.

17. The method of claim 16, wherein the PUSCH resource is a PUSCH resource granted by the network device.

18. The method of claim 17, further comprising:
sending, by the network device, a first radio resource control (RRC) signaling, wherein the first RRC signaling is configured to indicate the granted PUSCH resource, and the first RRC signaling comprises configured uplink grant information and an indicator,
wherein the indicator is configured to indicate the granted PUSCH resource configured for sending the positioning measurement result.

19. (canceled)

20. The method of claim 17, further comprising:
sending, by the network device, a second RRC signaling; and
sending, by the network device, a first downlink control information (DCI) signaling, wherein the second RRC signaling and the first DCI signaling are configured for the granted PUSCH resource.

21. The method of claim 17, further comprising:
sending, by the network device, a second DCI signaling, wherein the second DCI signaling is configured to schedule a PUSCH resource, and the granted PUSCH resource is the PUSCH resource scheduled by the second DCI signaling, and
wherein in response to the second DCI signaling scheduling multiple PUSCH resources, a PUSCH resource at a specified position among the multiple PUSCH resources carries the positioning measurement result; or the second DCI signaling further comprises a report type of the positioning measurement result.

22-23. (canceled)

24. The method of claim 17, wherein the granted PUSCH resource carries only the positioning measurement result.

25. The method of claim 21, wherein the second DCI signaling further comprises report trigger information, wherein the report trigger information is configured to trigger a user equipment (UE) to report the positioning measurement result, and
wherein the second DCI signaling further comprises at least one of at least one positioning reference signal (PRS) resource set ID and at least one PRS resource ID to be measured; or a channel state information (CSI) request indicator field is reused as an indicator field corresponding to the report trigger information.

26. (canceled)

27. The method of claim 21, wherein the second DCI signaling further comprises at least one of following:
whether to transmit the positioning measurement result on the granted PUSCH resource;
an identifier of the granted PUSCH resource used for sending the positioning measurement result;
a time domain position of the PUSCH resource;
information on a measurement gap for measuring a PRS;
information on a BWP ID for measuring the PRS; and
information on a panel for measuring the PRS.

28-32. (canceled)

33. A user equipment, comprising:
a transceiver;
a memory; and
a processor, connected to the transceiver and the memory respectively, and configured to, through executing computer-executable instructions on the memory, control wireless signal transmission and reception of the transceiver, thereby performing acts comprising:
acquiring a positioning measurement result; and
sending the positioning measurement result through a physical uplink shared channel (PUSCH) resource.

34. A network device, comprising:
a transceiver;
a memory; and
a processor, connected to the transceiver and the memory respectively, and configured to, through executing computer-executable instructions on the memory, control wireless signal transmission and reception of the transceiver, thereby implementing the method of claim 16.
